(19) United States
(12) Patent Application Publication
(10) Pub. No.: US 2008/0233289 A1
(43) Pub. Date: Sep. 25, 2008

(54) Dyes Comprising [(4-[2-Amino-3,6-Disulpho-8-Hydroxynaphth-1-Ylazo]Anilino)- 1,3,5-Triazinyl] Moities

(76) Inventor: Markus Gisler, Rheinfelden (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/573,015

(22) PCT Filed: Sep. 23, 2004
(86) PCT No.: PCT/IB04/03107

§ 371 Date: Mar. 22, 2006

(30) Foreign Application Priority Data
Sep. 23, 2003 (EP) 03021448.0

(51) Int. Cl. B05D 5/04; C09B 31/12; C09D 11/02; C09B 43/40

(52) U.S. Cl. 427/288; 534/797; 534/598; 106/31.13

(57) ABSTRACT

A dyestuff according to formula (1)

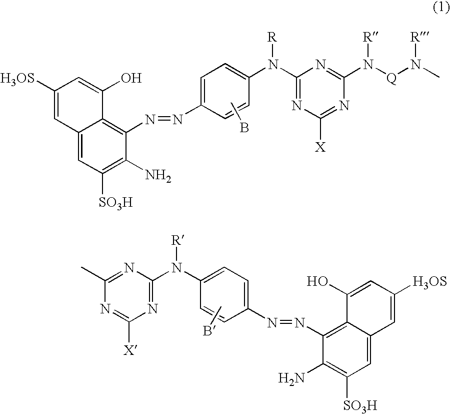

or a salt thereof wherein the substituents have the definitions as defined in claim 1.

The dyestuffs are useful for dyeing or printing nitrogen-containing or hydroxy-group-containing organic substrates and for the production of (ink-jet) printing inks.

This invention relates to dyes, to inks and to their use in ink jet printing and classical dyeing operations and classical printing operations.

Classical or conventional dyeing operations comprise exhaustion dyeing which works by diffusion of the dissolved dye into the fibers (batch and continuous dyeing). Classical or conventional printing processes are well known and differ in the way the printing ink or printing paste is transferred to the substrate: For example, inks or pastes can be applied by raised type (e.g. letter press, flexographic), from a planar surface (lithographic), from a recessed surface (intaglio) or through a stencil (silk screen). Different methods of application and different substrates require different properties in the ink. These operations are described for example in M. Peter, H. K. Rouette: Grundlagen der Textilveredlung, Handbuch der Technologie, Verfahren, Maschinen, 13th ed., Deutscher Fachverlag, Frankfurt 1989 (ISBN 3-87150-270-4) in the chapter 7.222.1 and chapter 7.222.2 on the page 484 to the page 495.

Dyes comprising bis[(4-[2-amino-3,6-disulpho-8-hydroxynaphth-1-ylazo]anilino)-1,3,5-triazinyl] moities are known from GB2331757. EP693538 A2 discloses mixtures of non-reactive, bridged monoazo direct dyes carrying triazine groups which are substituted by a piperazino group or a diamino group. However there is still a need for dyestuff haveing bis[(4-[2-amino-3,6-disulpho-8-hydroxynaphth-1-ylazo]anilino)-1,3,5-triazinyl] moities with improved properties, especially improved fastness to light.

According to the present invention there is provided a bis-azo compound of Formula (1) and salts thereof:

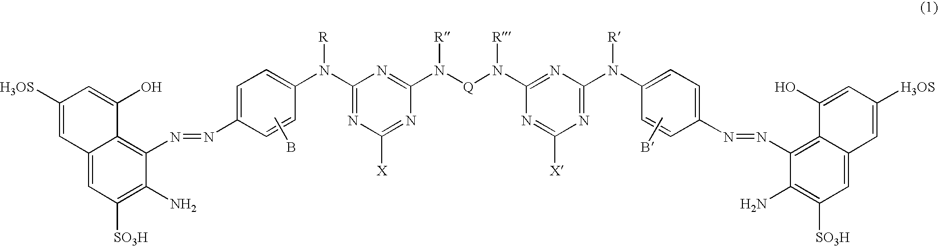

wherein:
B and B′ are each independently —SO3H, —COOH, substituted alkoxy, substituted alkyl, un-substituted alkoxy, un-substituted alkyl, or —PO₃H₂;
Q is an organic aliphatic linking group, which is either a un-substituted or substituted alkyl group which is not interrupted by any hetero atom or a un-substituted or substituted alkyl ether group comprising one oxygen atom or is a un-substituted or substituted alkyl polyamine group comprising one or two or more nitrogen atoms;
R, R′, R″ and R′″ are each independently H or un-substituted or substituted alkyl;
X and X′ are each independently a labile atom or group;
B and B′ are preferably attached ortho to the azo group. Preferably B and B′ are each independently —SO₃H, —COOH, alkoxy (preferably substituted C₁₋₄-alkoxy or substituted C₁₋₄alkoxy), alkyl (preferably un-substituted C₁₋₄-alkyl or substituted C₁₋₄-alkyl) or —PO₃H₂, more preferably —SO₃H or —COOH and especially —SO₃H. When B or B′ are substituted alkyl or substituted alkoxy the substituents are selected from —OH, —SO₃H, —COOH, —NH₂, C₁₋₄-hydroxyalkyl, C₁₋₄-hydroxyalkoxy and C₁₋₄-alkoxy. In preferred compounds B is equal to B′.

Preferably R, R′, R″ and R′″ are each independently H or un-substituted C₁₋₄-alkyl or substituted C₁₋₄-alkyl substituted by hydroxy, carboxy, sulpho or cyano or un-substituted C₁₋₄-alkoxy or substituted C₁₋₄-alkoxy substituted by hydroxy, carboxy, sulpho or cyano. More preferably R, R′, R″ and R′″ are each independently H or un-substituted C₁₋₄-alkyl or C₁₋₄-alkyl substituted by hydroxy, carboxy, sulpho or cyano. It is especially preferred that R, R′, R″ and R′″ are H, methyl, ethyl or ethyl substituted by hydroxy, more especially R, R′, R″ and R′″ are H.

When R, R′, R″ and R′″ are substituted alkyl or substituted alkoxy the substituents are selected from —OH, —SO₃H, —COOH, —NH₂, C₁₋₄-hydroxyalkyl, C₁₋₄-hydroxyalkoxy and C₁₋₄-alkoxy.

Preferrably R′″ is H while R″ H or un-substituted C₁₋₄-alkyl or substituted C₁₋₄-alkyl substituted by hydroxy, carboxy, sulpho or cyano or un-substituted C₁₋₄alkoxy or substituted C₁₋₄-alkoxy substituted by hydroxy, carboxy, sulpho or cyano.

The organic aliphatic linking group Q is preferably alkylene or alkylenylene, preferably C₂₋₂₀-alkylene, or C₂₋₂₀-alkylenylene, or substituted C₂₋₁₀-alkylene or substituted C₂₋₁₀-alkylenylene. The organic linking group Q may be substituted.

When the organic aliphatic linking group Q is interrupted by N, the N may further be substituted by one substituted or un-substituted alkyl or by one substituted or un-substituted aryl group, wherein the substituents for the alkyl or aryl groups may be selected from hydroxy, carboxy, sulpho and cyano.

The most preferred organic aliphatic linking groups Q are not interrupted by a hetero, especially the organic aliphatic linking groups Q are not interrupted by O or N. The most preferred linking groups are linear aliphatic linking which are not cyclic.

The substituent of Q are preferably selected from substituted or un-substituted alkyl, hydroxy, carboxy or sulpho, preferably hydroxy-C₁₋₄-alkyl, carboxy-C₁₋₄-alkyl or sulpho-C₁₋₄-alkyl; alkoxy, preferably —C₁₋₄-alkoxy and especially methoxy; phenyl optionally substituted by C₁₋₄-alkyl, carboxy, hydroxy, sulpho, cyano, amino or nitro, halo, preferably F or Cl; —SO₃H; —COOH; —OH; —CN; or —NO₂. The more preferred substituents are hydroxy, carboxy, sulpho, cyano, C₁₋₄-alkyl or C₁₋₄-alkoxy and the most more preferred substituents of Q are C₁₋₄-alkyl or C₁₋₄-alkoxy.

More preferred Q-groups are un-substituted C₁₋₄-alkylene groups or substituted C₁₋₄-alkylene groups. The most preferred Q-groups are un-substituted C₁₋₄-alkylene groups or substituted C₁₋₄-alkylene groups are those C₁₋₄-alkylene groups which are not interrupted by any hetero-atome, thus the most preferred Q-groups are un-substituted C₁₋₄-alkylene groups or substituted C₁₋₄-alkylene groups which are not interrupted by N or O-atoms.

Examples of un-substituted alkylene and substituted alkylene groups represented by Q include: ethylene; 1,2- and 1,3-propylene; 2-hydroxy-1,3-propylene; 1,4-, 2,3- and 2,4-butylene; 2-methyl-1,3-propylene; 2-(4′-sulphophenyl)-1,3-propylene; 2-methyl-2,4-pentylene; 2,2-dimethyl-1,3-propylene; 1-chloro-2,3-propylene; 1,6- and 1,5-hexylene; 1-(methoxycarbonyl)-1,5-pentylene; 1-carboxy-1,5-pentylene; 2,7-heptylene; and 3-methyl-1,6-hexylene.

The most preferred Q-groups are un-substituted C₁₋₃-alkylene groups and even more preferred un-substituted C₁₋₃-alkylene groups.

X or X′ is a labile atom or group, and it is preferably an atom or group which is displaceable by a hydroxyl group of cellulose under mildly alkaline aqueous conditions to form a covalent bond between the compound of Formula (1) and cellulose. Preferred labile atoms and groups represented by X or X′ include halogens, for example F and Cl; sulphonic acid groups; thiocyano groups; quaternary ammonium. F and Cl are the most preferred labile groups.

The compound of Formula (1) preferably contains-only two azo groups (—N═N—).

The compounds of the invention may be in the free acid or salt form. Preferred salts are water-soluble. Examples of such cations are alkali metal cations, e.g. lithium, sodium potassium, and ammonium cations or substituted ammonium cations, e.g. mono-, di-, tri- and tetra-methylammonium, tri-ethylammonium, mono-, di-, and tri-ethanolammonium, and ethoxylated mono-, di-, and tri-ethanolammonium. The preferred cations are the alkali metal cations and the ammonium cation, with the sodium cation being the most preferred.

The compounds may be converted into a salt using known techniques. For example, an alkali metal salt of a compound or the free acid may be converted into a salt with ammonia or an amine by dissolving an alkali metal salt of the compound or the free acid form respectively in water, acidifying with a mineral acid and adjusting the pH of the solution to pH 9 to 9.5 with ammonia or the amine and removing the alkali metal cations by dialysis, reverse osmosis or ultrafiltration.

The compounds of the invention may be prepared using conventional techniques for the preparation of azo dyes. For example a suitable method comprises condensing a compound of the Formula HN(R″)QN(R″)H with approximately 2 molar equivalents of a compound of the Formula (2):

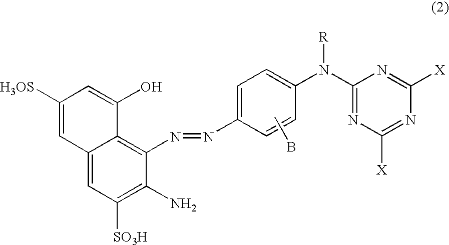

wherein Q, B, R, R″, R′″ and X are as hereinbefore defined.

Alternatively a further suitable method comprises condensing a compound of the Formula HN(R″)QN(R′″)H with approximately one molar equivalents of a compound of the Formula (2):

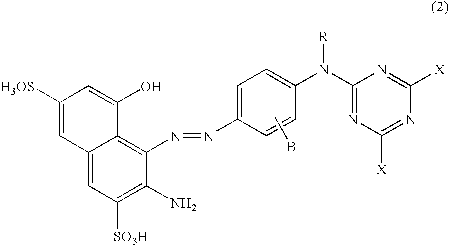

and then reacting the reaction product of the reaction of the compound of the Formula HN(R″)QN(R′″)H with the compound of the Formula (2) with a compound of Formula (2′)

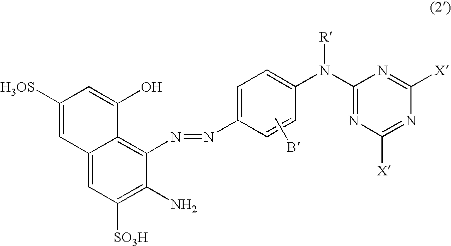

wherein B, B′, Q, R, R′, R″, R′″, X and X′ have the meaning as hereinabove defined.

The condensation is preferably performed in a liquid medium, more preferably an aqueous medium and especially water. Temperatures of 15° C. to 100° C. are preferred, more preferably from 30 to 40° C. Preferably a reaction time of 1 to 48, more preferably 3 to 24 hours is used.

The condensation is preferably performed in the presence of a base. The base may be any inorganic base for example, ammonia, an alkali metal or alkali earth metal hydroxide, carbonate or bicarbonate, or an organic base. Preferred organic bases are tertiary amines for example, N-alkylated heterocycles, for example N—(C₁₋₄-alkyl)morpholine, N—(C₁₋₄-alkyl)piperidine, N,N′-di(C₁₋₄-alkyl)piperazine; tri(C₁₋₄-alkyl)amines, for example triethylamine, and optionally substituted pyridines, especially pyridine. Further preferred amine compounds are mono-, di- and tri-methylamine, tri-ethylamine, mono-, di-, and tri-ethanolamine, and ethoxylated mono-, di-, and tri-ethanolamine.

After the condensation the product may be isolated by precipitating the product as a salt from the reaction mixture for example by the addition of a suitable alkali metal salt, especially sodium chloride. Alternatively, the product may be isolated in its free acid form by acidifying the reaction mixture, preferably using a mineral acid, especially hydrochloric acid. Where the product precipitates as a solid it may be separated from the mixture by filtration.

In a new dyestuff according to the invention, the cations can be the same or different, e.g., they can also be a mixture of the above mentioned cations meaning that the dyestuff can be in a mixed salt form.

If desired unwanted anions may be removed from the product of the above process by dialysis, osmosis, ultrafiltration or a combination thereof.

The product of the above process may be converted, if desired, to the NH₄⁺, quaternary ammonium or organic amine salt by the addition of ammonia, ammonium hydroxide, primary, secondary, tertiary or quaternary amine. When the base used in the condensation process is an organic amine an excess may be used so that the compound of formula (1) is formed as the organic amine salt.

The compound of the Formula (2) may be prepared using conventional techniques, for example by:

(1) diazotizing a compound of the Formula (3) to give the corresponding diazonium salt:

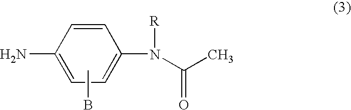

wherein R and B is as hereinbefore defined;
(2) coupling the diazonium salt from stage (1) with 2-amino-8-naphthol-3,6-disulphonic acid at a pH <7, preferably at a pH of from 3 to 5;
(3) hydrolyzing the product of stage (2) under alkaline conditions to give a compound of the Formula (4):

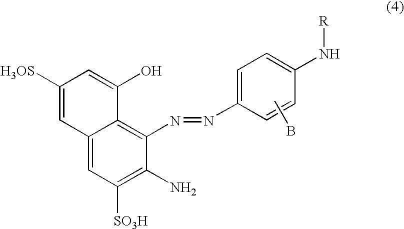

(4) condensing the product from stage (3) with approximately 1 molar equivalent of the compound of the formula (5):

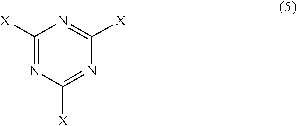

wherein B, R and X are as hereinbefore defined; and

The diazotization in stage (1) is preferably performed in an acidic aqueous medium in the presence of a suitable diazotization agent. Dilute mineral acid, e.g. HCl or H₂SO₄, is preferably used to achieve the desired acidic conditions. Conveniently the diazotization agent is formed in-situ, for example by dissolving an alkali metal nitrite, preferably sodium nitrite, in a molar excess of mineral acid, preferably HCL Normally at least one mole of diazotization agent per mole of the compound of Formula (3), preferably from 1 to 1.25 moles will be used in the diazotization.

The temperature of the diazotization is not critical and may conveniently be carried out at from −5° C. to 20° C., preferably from 0 to 10° C. and especially from 0 to 5° C.

The hydrolysis in stage (3) is preferably performed at a pH of from 9 to 14. The temperature during hydrolysis is preferably 40 to 90° C., more preferred at 50 to 65° C.

When B and B′, R and R′ or X and X′ are different, the compounds of Formula (1) are preferably prepared by condensing a compound of the Formula (2) with an approximately equimolar quantity of the compound of the formula HN(R″)QN(R′″)H. The product of this reaction is then further condensed with an approximately equimolar quantity of a compound of the Formula (2) wherein R is R′, B is B′ and X is X′ as hereinbefore defined.

Alternatively, a compound of formula (1) in which one or both of X and X are other than halogen, may be prepared by condensing a compound of formula (1), in which X═X′═Cl or F, with sufficient of a compound or compounds XH and/or X′H, wherein X and X′ are as hereinbefore defined except for Cl or F, under such conditions of temperature and/or time as to replace one or both Cl or F atoms.

The compounds according to the present invention may be, and preferably are, purified to remove undesirable impurities before they are incorporated into liquid dye preparations for conventional dyeing as well as for example for inks for ink jet printing or conventional printing. Conventional techniques may be employed for purifying the dyes, for example ultrafiltration, reverse osmosis and/or dialysis. For other uses, especially for conventional (classical) printing and dyeing operations may be purified by precipitating for example by salting out as well as purified by for example ultrafiltration, reverse osmosis and/or dialysis.

The new dyestuff or mixtures thereof are for dyeing or printing hydroxy group- or nitrogen-containing organic substrates. Preferred substrates are leather and fiber material comprising natural or synthetic polyamides and, particularly, natural or regenerated cellulose such as cotton, viscose and spun rayon. The most preferred substrate is textile material comprising cotton.

Dyeing or printing is effected in accordance with known methods conventional in the dyestuff field. It is preferred to effect dyeing of fiber-reactive dyestuffs using the exhaust dyeing method at temperatures within the range of 30-80° C., particularly at 50-60° C., and with a liquor to goods ratio of 6:1 to 30:1, more preferably of 10:1.

The new fiber-reactive dyestuff gives good exhaust and fixation yields when used as a dyestuff. Moreover, any unfixed compound is easily washed off the substrate. The dyeings and prints derived from the new fiber-reactive dyestuff exhibit good wet fastness properties such as wash, water, sea water and sweat fastness and in particular excellent light fastness. They also exhibit good resistance to oxidation agents such as chlorinated water, hypochlorite bleach, peroxide bleach and perborate-containing washing detergents.

The corresponding direct dyestuffs can be used as dyes directly or can be used in form of an aqueous, for example concentrated stabile solution, or in the form of their granulate in quaternary form and/or the mentioned salts of mineral acids or organic acids, for coloring fibers of all types, of cellulose, cotton or leather, particularly however paper or paper products.

The dyes can also be used in the production of pulp dyeing of bleached and unbleached paper. They can furthermore be used in dyeing paper according to the dip dyeing process.

The compounds of Formula (1) are useful as dyes, especially for the coloration of inks for ink jet printing. The dyes are also suitable for dyeing and printing in a conventional manner. The compounds exhibit a high solubility in aqueous media and provide prints and dyeings which exhibit improved high light-fastness and water-fastness when applied on a substrate or incorporated into inks for ink jet printing.

According to a second aspect of the present invention there is provided a composition comprising one or more compound(s) of the formula (1) or a salt thereof and a medium. The compositions according to the second aspect of the invention are useful as inks, particularly printing inks and especially ink jet printing inks. The compositions according to the second aspect of the invention are useful as printing pastes, ink-jet printing inks or in a dyeing path for dyeing a substrate.

In addition ink jet printing is a non-impact printing technique in which droplets of ink are ejected through a fine nozzle onto a substrate without bringing the nozzle into contact with the substrate. There are many demanding performance requirements for dyes and inks used in ink jet printing. The dyes according to the invention provide sharp, non-feathered images when applied by printing techniques (classical and non-impact printing techniques) having good water-fastness, light-fastness and optical density. Details of this technology are described for example in the Ink-Jet-Printing section of R. W. Kenyon in “Chemistry and Technology of Printing and Imaging Systems”, Peter Gregory (editor), Blackie Academic & Professional, Chapmann & Hall 1996, pages 113-138, and references cited therein.

The medium for ink jet rinting is preferably water, a mixture of water and an organic solvent, an organic solvent free from water, or a low melting point solid. A preferred composition comprises:
(a) from 0.01 to 30 parts of one or more compound(s) of the Formula (1) or salt thereof as hereinbefore defined; and
(b) from 70 to 99.99 parts of a medium comprising a mixture of water and an organic solvent, an organic solvent free from water, or a low melting point solid;
   wherein all parts are by weight and the number of parts of (a)+(b)=100.

The number of parts of component (a) is preferably from 0.1 to 20, more preferably from 0.5 to 15, and especially from 1 to 5 parts. The number of parts of component (b) is preferably from 99.9 to 80, more preferably from 99.5 to 85, especially from 99 to 95 parts.

When the medium is a mixture of water and an organic solvent or an organic solvent free from water, preferably component (a) is completely dissolved in component (b). Preferably component (a) has a solubility in component (b) at 20° C. of at least 10%. This allows the preparation of concentrates which may be used to prepare more dilute inks and reduces the chance of the compound of Formula (1) precipitating if evaporation of the liquid medium occurs during storage.

When the medium comprises a mixture of water and an organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₄-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; trials, preferably glycerol and 1,2,6-hexanetriol; mono-C₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-(2-(2-methoxyethoxy)ethoxy]ethanol, 2-[2-(2-ethoxyethoxy)-ethoxy]-ethanol and ethyleneglycol monoallylether, cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably the liquid medium comprises water and 2 or more, especially from 2 to 8, water-soluble organic solvents.

Especially preferred water-soluble organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

A preferred medium comprises:
(a) from 75 to 95 parts water; and
(b) from 25 to 5 parts in total of one or more solvents selected from diethylene glycol, 2-pyrrolidone, thiodiglycol, N-methylpyrrolidone, cyclohexanol, caprolactone, caprolactam and pentane-1,5-diol;
   wherein the parts are by weight and the sum of the parts (a) and (b)=100.

Examples of further suitable media comprising a mixture of water and one or more organic solvents are described in U.S. Pat. No. 4,963,189, U.S. Pat. No. 4,703,113, U.S. Pat. No. 4,626,284 and EP 4,251,50A.

When the liquid medium comprises an organic solvent free from water, (i.e. less than 1% water by weight) the solvent preferably has a boiling point of from 300 to 200° C., more preferably of from 40° C. to 150° C., especially from 50° C. to 125° C. The organic solvent may be water-immiscible, water-miscible or a mixture of such solvents. Preferred water-miscible organic solvents are any of the hereinbefore described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂ and ethers, preferably diethyl ether; and mixtures thereof.

When the liquid medium comprises a water-immiscible organic solvent, preferably a polar solvent is included because this enhances solubility of the dye in the liquid medium. Examples of polar solvents include C₁₋₄-alcohols. In view of the foregoing preferences it is especially preferred that where the liquid medium is an organic solvent free from water it comprises a ketone (especially methyl ethyl ketone) or an alcohol (especially a C₁₋₄-alkanol, more especially ethanol or propanol).

The organic solvent free from water may be a single organic solvent or a mixture of two or more organic solvents. It is preferred that when the medium is an organic solvent free from water it is a mixture of 2 to 5 different organic solvents. This allows a medium to be selected which gives good control over the drying characteristics and storage stability of the composition.

Media comprising an organic solvent free from water are particularly useful where fast drying times are required and particularly when printing onto hydrophobic and non-absorbent substrates, for example plastics, metal and glass.

Preferred low melting solid media have a melting point in the range from 60° C. to 125° C. Suitable low melting point solids include long chain fatty acids or alcohols, preferably those with C₁₋₂₄ chains, and sulphonamides. The compound of Formula (1) may be dissolved in the low melting point solid or may be finely dispersed in it.

The compounds according to the present invention exhibit a high solubility in aqueous media, accordingly it is preferred that the liquid medium is water or more preferably a mixture of water and one or more water miscible organic solvent(s).

The composition may also contain additional components conventionally used in ink jet printing inks, for example viscosity and surface tension modifiers, corrosion inhibitors, biocides, kogation reducing additives and surfactants which may be ionic or non-ionic.

When a composition according to the second aspect of the present invention is used as an ink jet printing ink, the ink preferably has a concentration of less than 100 parts per million, more preferably less than 50 parts per million, in total of halide ions and divalent and trivalent metals. This reduces nozzle blockage in ink jet printing heads, particularly in thermal ink jet printers.

A third aspect of the present invention provides a process for printing an image on a substrate comprising applying thereto an ink containing a compound of Formula (1) by means of an ink jet printer.

The ink used in this process preferably comprises a composition as defined in the second aspect of the present invention.

The ink jet printer preferably applies the ink to the substrate in the form of droplets which are ejected through a small orifice onto the substrate. Preferred ink jet printers are piezoelectric inkjet printers and thermal ink jet printers. In thermal ink jet printers, programmed pulses of heat are applied to the ink in a reservoir by means of a resistor adjacent to the orifice, thereby causing the ink to be ejected in the form of small droplets directed towards the substrate during relative movement between the substrate and the orifice. In piezoelectric ink jet printers the oscillation of a small crystal causes ejection of the ink from the orifice.

The substrate is preferably paper, plastic, a textile, metal or glass, more preferably paper, an overhead projector slide or a textile material, especially a textile material.

When the substrate is a textile material the ink according to the invention is preferably applied thereto by:

i) applying the composition to the textile material using an ink jet printer, and
ii) heating the printed textile material at a temperature of from 50° C. to 250° C.

Preferred textile materials are natural, synthetic and semi-synthetic materials. Examples of preferred natural textile materials include wool, silk, hair and cellulosic materials, particularly cotton, jute, hemp, flax and linen. Examples of preferred synthetic and semi-synthetic materials include polyamides, polyesters, polyacrylonitriles and polyurethanes.

Preferably the textile material has been treated with an aqueous pre-treatment composition comprising a thickening agent and optionally a water-soluble base and a hydrotropic agent and dried prior to step i) above.

The pre-treatment composition preferably comprises a solution of the base and the hydrotropic agent in water containing the thickening agent. Particularly preferred pre-treatment compositions are described more fully in EP534660A1.

According to a fifth aspect of the present invention there is provided an ink jet printer cartridge containing an ink, characterized in that the ink contains one or more compound(s) of the Formula (1) or salts thereof as defined in the first aspect of the invention.

Preferably the ink contained in the ink jet printer cartridge is an ink according to the second aspect of the present invention.

The invention is further illustrated by the following Examples in which all parts and percentages are by weight unless otherwise stated.

### EXAMPLE 1

Dye (1) was prepared using the process described below:

### Stage (i): Diazotization and Coupling

To N-acetyl-p-phenylenediamine sulphonic acid (0.5 moles) in water (800 ml) was added concentrated hydrochloric acid (150 ml) and the solution was cooled to 0-5° C. 2N sodium nitrite (250 ml) was added dropwise over 60 minutes with stirring. After 15 minutes, excess nitrous acid was destroyed by the addition of sulphaminic acid (0.2 g). To the resulting suspension was added a solution of 2-amino-8-naphthol-3,6-disulphonic acid (0.5 moles in 700 ml of water at pH=6) and the pH was adjusted to 4 by the addition of sodium acetate. The mixture was stirred at 0-5° C. for 4 hours before being allowed to warm to room temperature.

### Stage (ii) Hydrolysis

The acetyl group present on the product of stage (i) was removed by alkaline hydrolysis by adding concentrated sodium hydroxide (200 ml) to the mixture resulting from stage I and heating at 60-65° C. for 15 hours.

After cooling to room temperature, the pH was adjusted to 7 by the addition of concentrated hydrochloric acid. Sodium chloride (20% weight-volume) was added and the precipitated solid was collected by suction filtration, washed with 30% brine and dried at 70° C. Yield 210 g (strength 50%).

Stage (iii) Condensation with Cyanuric Chloride

The product from stage (ii) (208 g) was dissolved in water (1600 ml) at pH 7 and cooled to 5-10° C. Cyanuric chloride (37 g) in acetone (200 ml) was added dropwise with stirring over a period of 30 minutes and the mixture was stirred for a further 1 hour. The pH of the solution was kept at a value of 4 to 5 by addition of sodium carbonate.

### Stage (iv) Condensations

Ethylenediamine (6.2 g) was added and the mixture was stirred at 30° C. for 7 hours. The pH of the solution was kept at a value of 7 to 8 by addition of sodium carbonate. The precipitated dyestuff was filtered of and was dried at 70° C. under reduced pressure.

Yield 200 g (strength 64%). λ (max) was 524 nm.

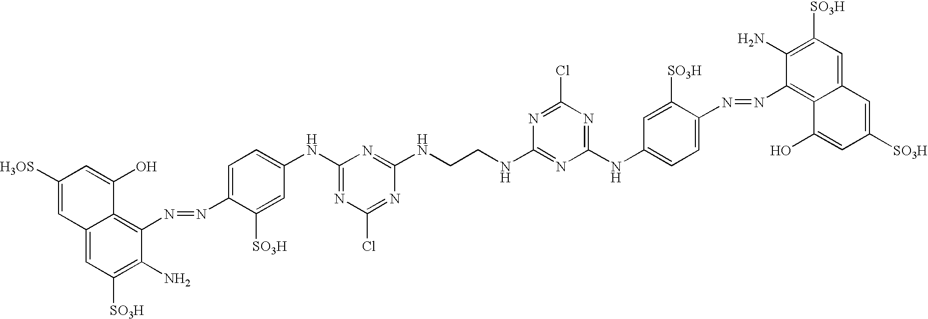

Its dyeing on cotton shows a bluish-red shade with outstanding lightfastness properties.

### EXAMPLES 2 TO 8

Dyes of the formula:

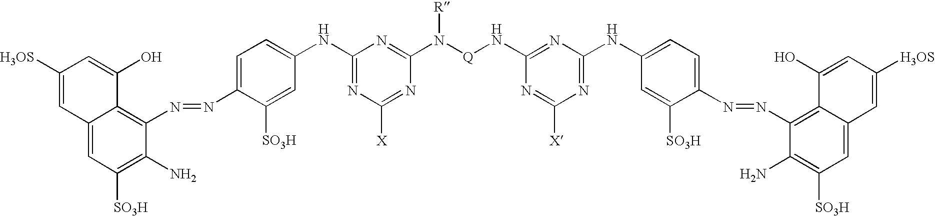

were prepared by condensing the compound HR″N-Q-NH₂ shown in Table 1 with approximately 2 molar equivalents of the product of stage (iii) in Example 1. The reaction conditions used were analogous to those used in stage (iv) of Example 1. For the derivatives wherein X and/or X′ signifies F the corresponding cyanuric fluoride was reacted without acetone and the reaction was carried out at −5° C. in the Stage (iii) Condensation with cyanuric fluoride.

TABLE 1

| | | X and | λ |
|---|---|---|---|
| Example | H₂N-Q-NHR″ | X′ | (max) |
| 2 | H₂N—CH₂—CH₂—CH₂—NH₂ | Cl | 521 |
| 3 | H₂N—CH₂—CH(OH)—CH₂—NH₂ | Cl | 520 |
| 4 | H₂N—CH₂—CH(CH₃)—NH₂ | Cl | 524 |
| 5 | H₂N—CH₂—CH₂—NH—CH3 | Cl | 520 |
| 6 | H₂N—CH₂—CH₂—NH₂ | F | 522 |
| 7 | H₂N—CH₂—CH(OH)—CH₂—NH₂ | F | 519 |
| 8 | H₂N—CH₂—CH(CH₃)—NH₂ | F | 523 |
| 9 | H₂N—CH₂—CH₂—CH₂—NH₂ | F | 520 |
| 10 | H₂N—CH₂—CH₂—NH—CH₃ | F | 520 |
| 11 | H₂N—CH₂—CH₂—NH—CH₂—CH₂—OH | F | 521 |
| 12 | H₂N—CH₂—CH₂—NH—CH₂—CH₂—OH | Cl | 520 |

The following examples illustrate the possibilities of use of the described dyestuffs. The chlorine-containing dyestuffs are dyed according to Application Example A and the fluorine-containing dyestuffs according to Application Example B.

### APPLICATION EXAMPLE A

A dye bath consisting of 1000 parts of demineralized water, 80 parts of Glauber's salt (calcined), 1 part of sodium salt of 1-nitrobenzene-3-sulphonic acid and 1 part of the dyestuff from Example 1 was heated to 80° C. over the course of 10 minutes. Thereafter, 100 parts of mercerized cotton were immersed in the resultant solution. Dyeing was effected at 80° C. over 5 minutes before the solution was raised to 95° C. over 15 minutes. After 10 minutes at 95° C., 3 parts of soda were added, followed by a further 7 parts of soda after 20 minutes, and another 10 parts of soda after 30 minutes at 95° C. Dyeing subsequently continued for 60 minutes at 95° C. The dyed material was then removed from the dye bath, and rinsed for 2 minutes under running demineralized water at 60° C.±10° C. and for 1 minute under running tap water at 60° C.±10° C. The material was then washed twice for 10 minutes, each time in 5000 parts of boiling demineralized water, and subsequently rinsed for 2 minutes under running demineralized water at 60° C.±10° C., 1 minute under running tap water at 60° C.±10° C. and 1 minute under cold tap water. After drying, a bluish-red cotton dyeing with good fastness was obtained.

### APPLICATION EXAMPLE B

To the dyebath containing in 100 parts of demineralized water 5 parts of Glauber's salt (calcined), 10 parts of cotton fabric (bleached) are added. The bath is heated to 50° C. within 10 minutes, and 0.5 part of the dyestuff of Example 6 is added. After 25 minutes at 50° C., 0.7 parts of soda were added, followed by a further 1.3 parts of soda after 20 minutes, and another 2 parts of soda after 30 minutes at 50° C. The bath was subsequently heated over the course of 15 minutes to 60° C., and dyeing continued for 60 minutes at 60° C. The dyed material was then removed from the dye bath, and rinsed for 2 minutes under running demineralized water at 60° C.±10° C. and for 1 minute under running tap water at 60° C.±10° C. The dyed material was then washed twice for 10 minutes, each time in 5000 parts of boiling demineralized water, and subsequently rinsed for 2 minutes under running demineralized water at 60° C.±10° C., 1 minute under running tap water at 60° C.±10° C. and 1 minute under cold tap water. After drying, a bluish-red cotton dyeing with good fastness was obtained. The dyestuffs of Examples 2 to 12 or dyestuff mixtures of Examples 1 to 12 were used for dyeing cotton in an analogous manner to that described in Examples A and B. bluish-red dyeings were obtained, which displayed good fastness properties.

### APPLICATION EXAMPLE C

A printing paste having the components

40 parts of the dyestuff of Example 1
100 parts of urea
330 parts of water
500 parts of a 4% sodium alginate thickener
10 parts of the sodium salt of 1-nitrobenzene-3-sulphonic acid
20 parts of soda
1000 parts in all
was applied to cotton material by conventional printing processes. The printed and dried material was steamed for 4-8 minutes at 102° C. to 105° C. before being given a cold and a hot rinse. The fixed cotton material was subsequently washed at the boil (analogously to Example A) and dried. The bluish-red print obtained had good all-round fastness properties.

The dyestuffs of examples 2 to 12 were also used for printing cotton analogously to the method of example C. In all cases, bluish-red prints with good fastness properties were obtained.

1. A compound of Formula (1) or a salt thereof: 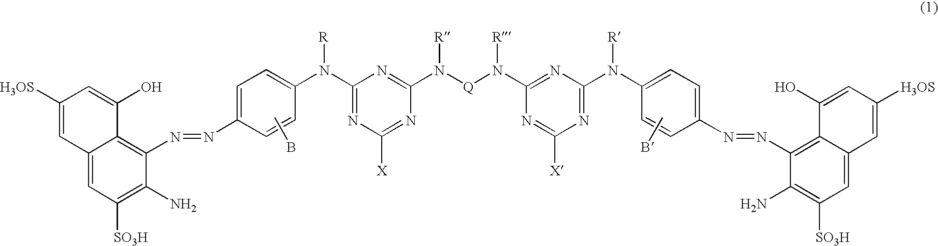
wherein:
B and B′ are each independently —SO3H, —COOH, substituted alkoxy, substituted alkyl, un-substituted alkoxy, un-substituted alkyl, or —PO₃H₂;
Q is an organic aliphatic linking group, which is either a un-substituted or substituted alkyl group which is not interrupted by any hetero atom or a un-substituted or substituted alkyl ether group comprising one oxygen atom or is a un-substituted or substituted alkyl polyamine group comprising one or two or more nitrogen atoms;
R, R′, R″ and R′″ are each independently H or unsubstituted or substituted alkyl;
X and X′ are each independently a labile atom or group.

2. A compound according to claim 1 wherein the organic aliphatic linking group Q is an alkylene.

3. A compound according to claim 2 wherein the organic aliphatic linking group Q is an unsubstituted or substituted C₁₋₄-alkylene group.

4. A compound according to claim 1 wherein X and X′ are F.

5. A compound according to claim 1 wherein B and B′ are ortho to the diazo bridge and are —SO₃H.

6. A process for the production of a compound of formula (1) according to claim 1 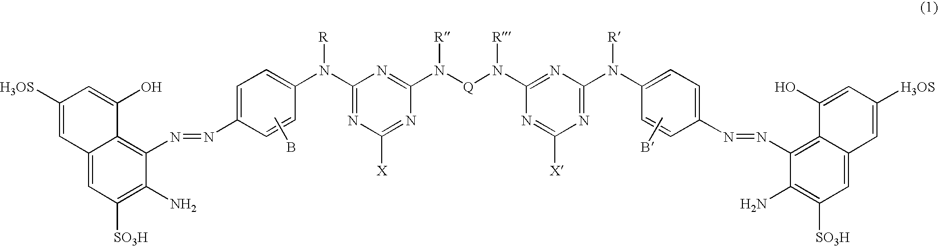
comprising the steps of:
condensing a compound of the formula HN(R″)QN(R′″)H with approximately one molar equivalent of a compound of the Formula (2) to form a reaction product: 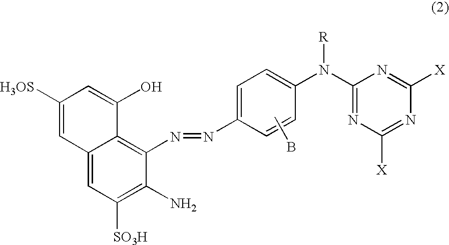
and reacting the reaction product with a compound of Formula (2′).

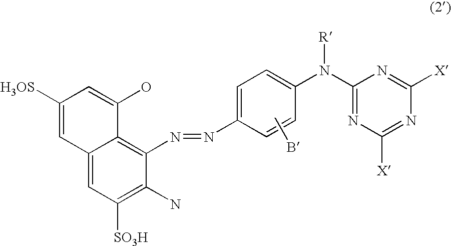

7. A process of dyeing or printing or ink jet printing a hydroxy-group-containing or a nitrogen containing organic substrate, comprising the steps of:
providing a substrate containing a hydroxy group or a nitrogen group;
providing a compound or compounds of formula (1) according to claim 1 their salt or mixture thereof, and
dyeing or printing or ink jet printing said substrate with said compound or compounds, their salt or mixture thereof.

8. A process according to claim 7, wherein said hydroxy-group-containing or nitrogen containing organic substrate is leather or a fibrous material, wherein the fibrous materials comprises natural or synthetic polyamides or natural or regenerated cellulose.

9. A process according to claim 7 wherein the substrate is a textile material comprising cotton.

10. A hydroxy group-containing or nitrogen containing substrate dyed or printed or ink jet printed according to claim 7.

11. (canceled)

12. An ink jet ink comprising compounds according to claim 1, their salts or mixtures thereof.

13. A compound according to claim 1, wherein the organic aliphatic linking group Q is a C₂₋₂₀-alkylene or a C₂₋₂₀-alkylenylene.

14. A compound according to claim 1 wherein X and X′ are Cl.

15. A compound according to claim 1 wherein B and B′ are —SO₃H and are ortho to the diazo bridge.
